(19) United States
(12) Patent Application Publication
(10) Pub. No.: US 2026/0058387 A1
(43) Pub. Date: Feb. 26, 2026

(54) Twin-ax Gauge Transition Connector

(71) Applicant: Cu Velocity LLC, Little Rock, AR (US)

(72) Inventors: Rehan M. Khan, Suwanee, GA (US); Richard H. Miller, Eastman, GA (US)

(21) Appl. No.: 19/309,319

(22) Filed: Aug. 25, 2025

Related U.S. Application Data
(60) Provisional application No. 63/686,608, filed on Aug. 23, 2024.

(51) Int. Cl. H01R 12/75; H01R 12/51; H01R 13/405; H01R 13/50; H01R 13/6594; H01R 13/66

(52) U.S. Cl. CPC H01R 12/75; H01R 12/515; H01R 13/405; H01R 13/50; H01R 13/6594; H01R 13/6658

(57) ABSTRACT

A transition connector allowing high speed data center wiring shifts between distinct wire gauges. The efficient adapter connects to each gauge and bridges the signal impedance so that neither side sees a disruption to its expected carrier properties. The transition connector can be used with multiple gauges of wire interchangeably allowing for modular deployment while maximizing equipment deployment duration.

The current application claims a priority to the U.S. Provisional Patent application Ser. No. 63/686,608 filed on Aug. 23, 2024.

### FIELD OF THE INVENTION

The present invention relates generally to electrical cables. Specifically, the present invention is an assembly for digital data transmission cables.

### BACKGROUND OF THE INVENTION

Data transmission cabling is used to transfer digital signals from one location to another. Data transmission cabling is commonly used in datacenter racks connecting servers, switches, and storage compute trays together to build a network. As datacenter racks become capable of more and more input and output channels, there is a need for data transmission cabling to become smaller and smaller yet also have lower and lower electrical loss for efficient data transmission.

The present invention addresses the issue of compatibility as the datacenter upgrades. By providing an efficient transition between new smaller cables and larger legacy cables, the data center is able to continue upgrading without immediately phasing out existing, otherwise incompatible, equipment. Essentially, where the transition connection is needed, an adapter is placed in between the distinct wire gauges, where the adapter corrects for the different signal profiles and traffic is able to flow between the two segments without disruption or excessive loss.

### BRIEF DESCRIPTION OF THE DRAWINGS

FIG. 1 is a configuration diagram for an embodiment of the present invention.

FIG. 2 is an alternate configuration diagram for an embodiment of the present invention.

FIG. 3 is a perspective view for an embodiment of the present invention.

### DETAIL DESCRIPTIONS OF THE INVENTION

All illustrations of the drawings are for the purpose of describing selected versions of the present invention and are not intended to limit the scope of the present invention.

Data transmission cable assemblies carry high speed signals to and from the chip to and from the backplane and I/O ports in the datacenter rack. The various compute trays in the datacenter rack have connectors that are getting smaller and smaller. Some of these small connectors are located to the metal panel of the compute tray and other connectors are attached near the computer chip inside the tray on the printed circuit board (PCB) or the chip substrate. The twin-ax and coax cables connecting to these small connectors need to remain large to support the lower electrical loss. But at the same time the cable needs to be small so it can fit into the small high-density connectors.

This invention is a novel solution of a transition connector that allows both needs to be met. This is done by connecting small gauge twin-ax to large gauge twin-ax in one or more places in the length of the data transmission cable assembly. For example, a 700 mm cable connecting from the metal panel to near the computer chip can be small at the connector ends but transition to be large after a distance of say 50 mm. The 50 mm could be 34 awg twin-ax and after the transition connector the longer part of the cable assembly is now 24 awg twin-ax cable. In order for this to work, the transition connector connecting the 2 sizes of twin-ax cables is designed to have matched impedance. The length of the small and large portion of the cable can be varied within a bundle of cables to stagger the location of the transition connectors. This would require an individual transition connector for each twin-ax or coax. Alternatively, a common transition connector can be used to connect many twin-ax cables, small-to-large, or large-to-small. This common transition connector embodiment would require greater consideration for cross-talk between twin-ax cables.

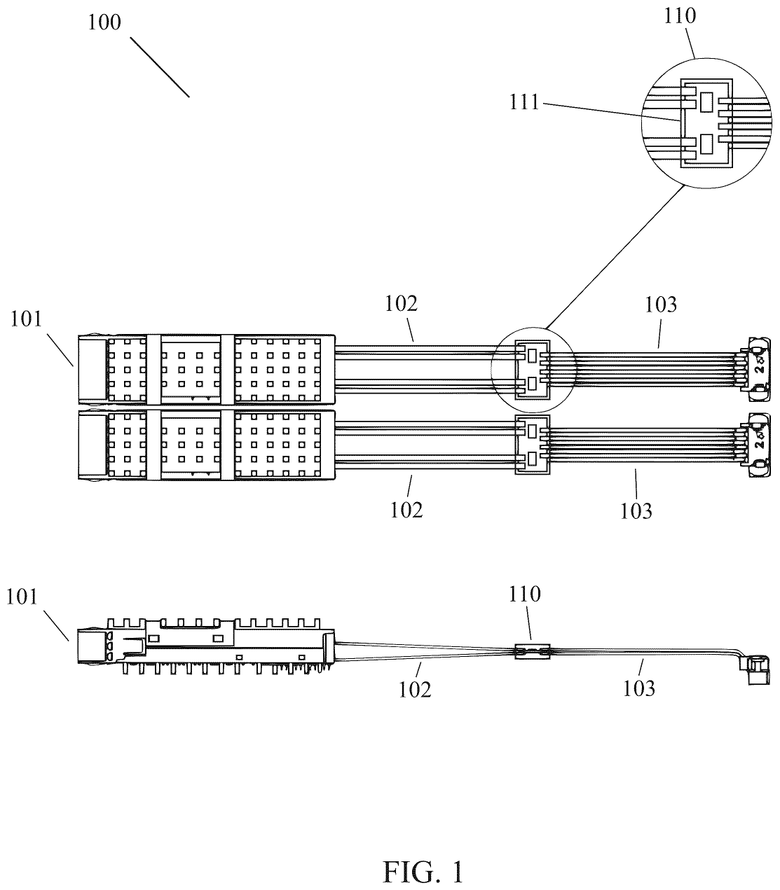

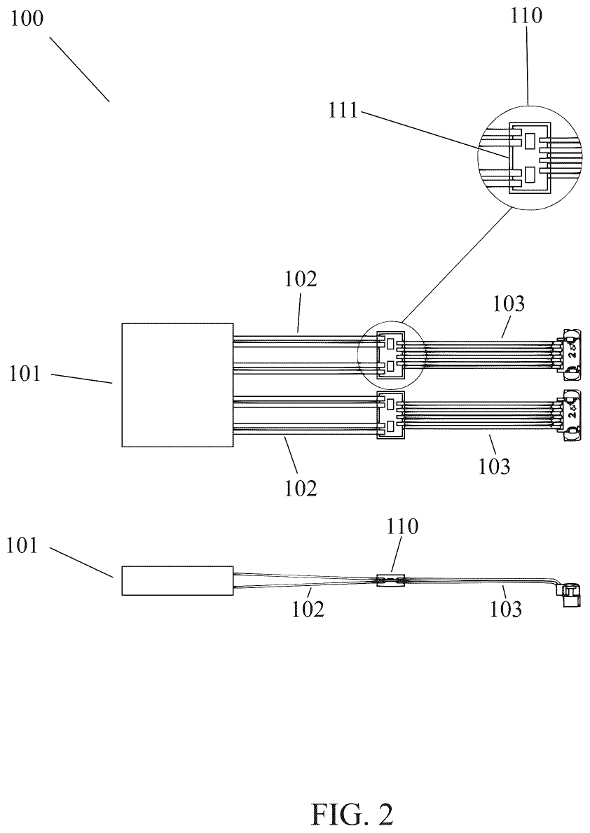

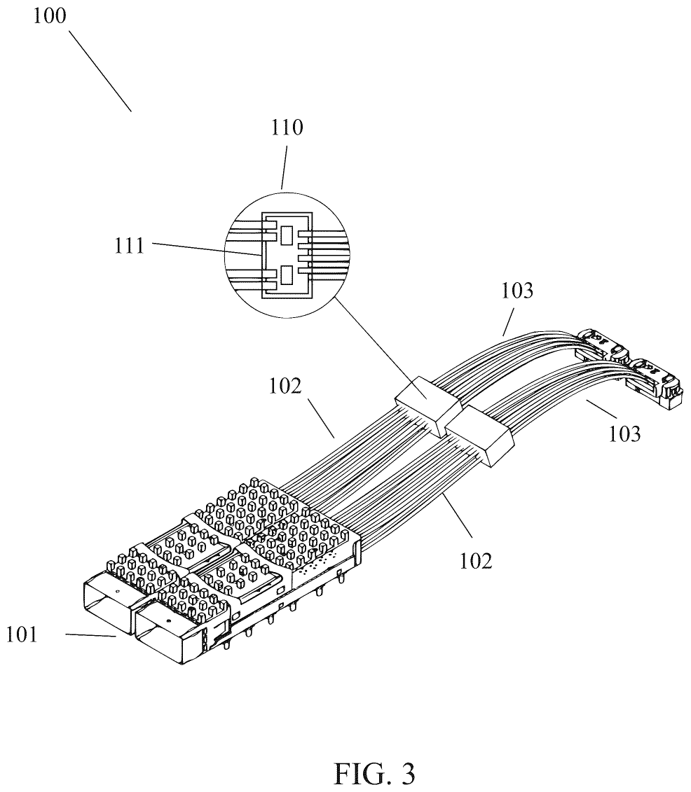

FIGS. 1-3 demonstrate embodiments of the transition connector. The cable assembly (100) comprises a data source channel (101), a source cable array (102), an output cable array (103), and a transitional connector (110). The transitional connector comprises circuitry (111) that modulates the impedance between the connected cable arrays. The data source channel (101) will be in connection with the high-speed I/O of the datacenter and/or its backplane. The source cable array (102) will generally be the smallest of the smallest gauge usable by the datacenter in most embodiments. FIGS. 1-3 suggest a size of roughly 28-22 awg for the source cable array (102), though the specific sizes can be different for each transition. The output cable array (103) will generally comprise of cables of a larger gauge than the source cable array, to more efficiently transmit the data. FIGS. 1-3 suggest a size of roughly 34-30 awg for the output cable array (103), though the specific sizes can be different for each transition in the same manner as the source cable array (102). Additionally, the output cable array (103) may comprise multiple gauges.

The transitional connector (110) ensures an operable signal between the source cable array (102) and the output cable array (103) by normalizing the impedance of the connected arrays. The wires for each array (102, 103) are stripped to their ends facilitating a connection directly with the transitional connector (110). The dielectric and shielding elements of the constituent cables are also joined with the transitional connector (110) to maintain signal integrity. Some embodiments may include additional shielding and/or insulation to further protect the connection to one or both of the cable arrays. The additional shielding and/or insulation material may be molded onto the PCB or chip substrate at the point of connection. Embodiments will often incorporate a plastic casing for providing physical protection and additional insulation to the wired connections.

Some embodiments may utilize air vacuum pockets to supplement or replace physical dielectric materials at the connector.

Although the invention has been explained in relation to its preferred embodiment, it is to be understood that many other possible modifications and variations can be made without departing from the spirit and scope of the invention.

1. A cabling assembly, the assembly comprising:
a data source channel;
a source cable array;
an output cable array; and
a transitional connector;
wherein
the source cable array connects the data source channel to the transitional connector;
the transitional connector is subsequently connected to output cable array;
the output cable array comprises cables of a larger gauge than the source cable array; and
the transitional connector matches impedance values between the source cable array and the output cable array;

2. The assembly of claim 1, wherein the data source channel receives data from one or more high-speed I/O channels from a data center.

3. The assembly of claim 1, wherein the data source channel receives data from one or more backplane I/O channels from a data center.

4. The assembly of claim 1, wherein the transitional connector is formed from a printed circuit board.

5. The assembly of claim 1, wherein the transitional connector is formed on a chip substrate.

6. The assembly of claim 1, wherein the transitional connector further comprises supplemental shielding material encasing connection points between the transitional connector and each of the cable arrays.

7. The assembly of claim 1, wherein the transitional connector further comprises supplemental dielectric structure encasing connection points between the transitional connector and each of the cable arrays.

8. The assembly of claim 7, wherein the supplemental dielectric structure is formed from one or more air pockets.

9. The assembly of claim 1, wherein the transitional connector further comprises a protective plastic casing enveloping the connector and connection points to each of the cable arrays.

10. The assembly of claim 9, wherein the protective plastic casing comprises an electrically insulative material.
